(19) United States
(12) Patent Application Publication
(10) Pub. No.: US 2001/0030431 A1
(43) Pub. Date: Oct. 18, 2001

(54) Safety compliant rear underride bumper

(76) Inventor: Timothy G. Killday, Columbia, MO (US)

Correspondence Address: TREXLER, BUSHNELL, GIANGIORGI, BLACKSTONE & MARR, LTD., 105 W. ADAMS STREET, CHICAGO, IL, 60603, US

(21) Appl. No.: 09/732,988

(22) Filed: Dec. 8, 2000

Related U.S. Application Data
(60) Provisional application No. 60/170,180, filed on Dec. 10, 1999.

(51) Int. Cl. B60R 19/38

(52) U.S. Cl. 293/118

(57) ABSTRACT

The present invention provides a novel bumper assembly for a vehicle, such as a truck, truck body or a trailer, that allows the bumper of the bumper assembly to be moved from a lowered position suitable for driving on the road, to a raised, hidden position at the rear end of the vehicle that is suitable for off the road activity, i.e., the lowering of the rear end of the vehicle to the ground to allow for the loading or unloading of cargo from the vehicle.

### CROSS-REFERENCE

This patent application claims the benefit of domestic priority of U.S. Provisional Application Ser. No. 60/170,180, filed Dec. 10, 1999.

### BACKGROUND OF THE INVENTION

The present invention relates to an underride bumper assembly for a vehicle, such as a truck, truck body or over the road trailer.

Trucks, truck bodies and over the road trailers are required to have rear bumpers thereon in order to prevent damage to an automobile that has hit the vehicle from behind.

Most rear bumpers on vehicles are a permanent fixture at the back of the vehicle, i.e., they are immovable. Most trucks, truck bodies and over the road trailers utilize what is known as a standard frame mounted rear underride bumper. An underride bumper is mounted to the frame of the vehicle and is fixed in position.

Such a standard frame mounted rear underride bumper can cause problems for different types of vehicles because of their off the road activities. For instance, some types of over the road flatbed trailers set the rear of the trailer down to the ground by way of a slide frame assembly. These types of trailers may utilize a deck of rollers to roll off or unload materials down to the ground level. These types of flatbed trailers lower their rear to the ground in order to allow for ease in loading and unloading of cargo and to minimize any damage to the cargo during loading or unloading. For these types of trailers, a standard frame mounted rear underride bumper hinders the off the road activities as a standard frame mounted rear underride bumper does not allow the rear end of the frame of the trailer to be placed on the ground. Instead, the rear end of the frame of the trailer is spaced from the ground by the height of the bumper.

Further, the National Highway Traffic Safety Administration (NHTSA) of the Department of Transportation (DOT) has recently implemented new safety requirements for bumpers under 49 C.F.R. 571.223. These requirements require not only certain dimensions and placement of the bumper itself, but they also have impact absorption requirements that dictate the structural construction of the bumper which can be prohibitive to the operation of vehicles that perform off the road activities. Because of these requirements, the rear underride bumper would have to be mounted in a manner that would either be cumbersome to move the bumper into different positions or make it very difficult, or impossible, to actually utilize certain operations of a vehicle.

Thus, there is a need for a bumper assembly for a vehicle that allows the bumper of the vehicle to be in both a road position while the vehicle is on the road as well as an off-road, or a hidden position, where the bumper will not impede with the off-road activities. Such a bumper assembly must also meet all of the safety requirements of 49 C.F.R. 571.223. The present invention provides such a novel bumper assembly.

### OBJECTS AND SUMMARY OF THE INVENTION

A primary object of the present invention is to provide a novel rear bumper assembly for a vehicle that can be moved from a lowered road position to a raised hidden position.

Another primary object of the present invention is to provide a novel rear underride bumper assembly for a vehicle that is compliant with all requirements of the DOT and NHTSA while in the road position that can be moved to a hidden position to allow for off the road activities.

An object of the present invention is to provide a novel rear underride bumper assembly for a vehicle that can be moved from a lowered road position to a hidden raised position via powered mechanical means versus manual mechanical means or means that require complete removal of the bumper assembly for off the road activities of the vehicle.

Another object of the present invention is to provide a novel rear underride bumper assembly for a vehicle that allows for easy repair or retrofit of the bumper assembly in cases of damage due to use, misuse or accident because the bumper assembly can be easily removed from the vehicle, and a new bumper assembly attached to the vehicle.

Another object of the present invention is to provide a novel rear underride bumper assembly for a vehicle that, in cases of use, misuse or accident, will deform or fail in a manner that does not harm the vehicle.

Yet another object of the present invention is to provide a novel rear underride bumper assembly for a vehicle that is able to stay in either a lowered road position or a raised hidden position without the use of some type of keeper or lock mechanism.

Still another object of the present invention is to provide a novel rear underride bumper assembly for a vehicle wherein if the rear end of the vehicle moves from a road position to a ground position, and the operator fails to activate the rear underride bumper assembly into the hidden position, the bumper assembly will move to the hidden position without damage.

Another object of the present invention is to provide a novel rear underride bumper assembly for a vehicle that can be recessed under the rear end of the vehicle such that the assembly does not impede the loading or unloading of the vehicle.

Still another object of the present invention is to provide a novel rear underride bumper assembly for a vehicle that can be moved from a lowered road position to a raised hidden position from a remote location on the vehicle.

Briefly, and in accordance with the foregoing, the present invention provides a novel bumper assembly for a vehicle, such as a truck, truck body or a trailer, that allows the bumper of the bumper assembly to be moved from a lowered position suitable for driving on the road, to a raised, hidden position at the rear end of the vehicle that is suitable for off the road activity, i.e., the lowering of the rear end of the vehicle to the ground to allow for the loading or unloading of cargo from the vehicle.

### BRIEF DESCRIPTION OF THE DRAWINGS

The features of the present invention which are believed to be novel are described in detail hereinbelow. The organization and manner of the structure and operation of the invention, together with further objects and advantages thereof, may best be understood by reference to the following description taken in connection with the accompanying drawings wherein like reference numerals identify like elements in which:

FIG. 1 is a perspective view of a vehicle having its rear end lowered to the ground and showing the bumper of the present invention in its raised position;

FIG. 2 is a rear view of the bumper assembly of the present invention showing the bumper in its lowered position;

FIG. 3 is a side view of the bumper assembly of the present invention showing the bumper in its lowered position;

FIG. 4 is a side view of the bumper assembly of the present invention showing the bumper in its raised position;

FIG. 5 is a side view of a bell member of the bumper assembly;

FIG. 6 is a side view of the bumper having a bumper cap thereon; and

FIG. 7 is a front view of a reinforcement member used in the present invention.

### DETAILED DESCRIPTION OF THE ILLUSTRATED EMBODIMENTS

While this invention may be susceptible to embodiment in different forms, there is shown in the drawings and will be described herein in detail, a specific embodiment with the understanding that the present disclosure is to be considered an exemplification of the principles of the invention, and is not intended to limit the invention to that as illustrated.

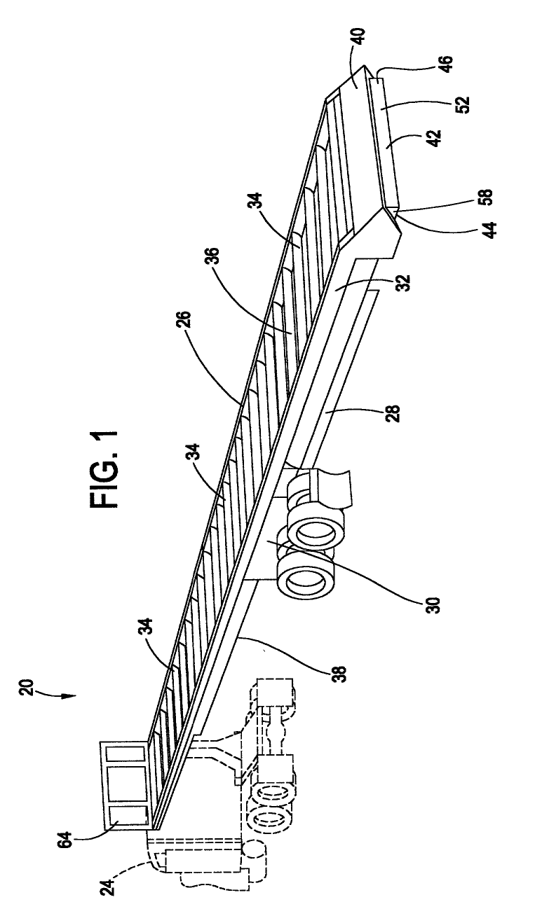

FIG. 1 shows a vehicle 20 for which the bumper assembly 22 of the present invention is suitable to be used on. The vehicle 20 includes a tractor 24 and a trailer 26 that has a slide frame assembly 28. A rear undercarriage assembly 30 is connected to the slide frame assembly 28. The trailer 26 is formed of a frame 32 that may have rollers 34 on a top surface 36 thereof. The bumper assembly 22 is attached to a bottom surface 38 of a rear end 40 of the frame 32 of the trailer 26.

It should be noted that while the vehicle 20 shown and described is the preferred type of vehicle for which the bumper assembly 22 of the present invention is attached to and used with, other types of vehicles, such as trucks, truck bodies, or other types of trailers, can also be fitted with such the bumper assembly 22 of the present invention.

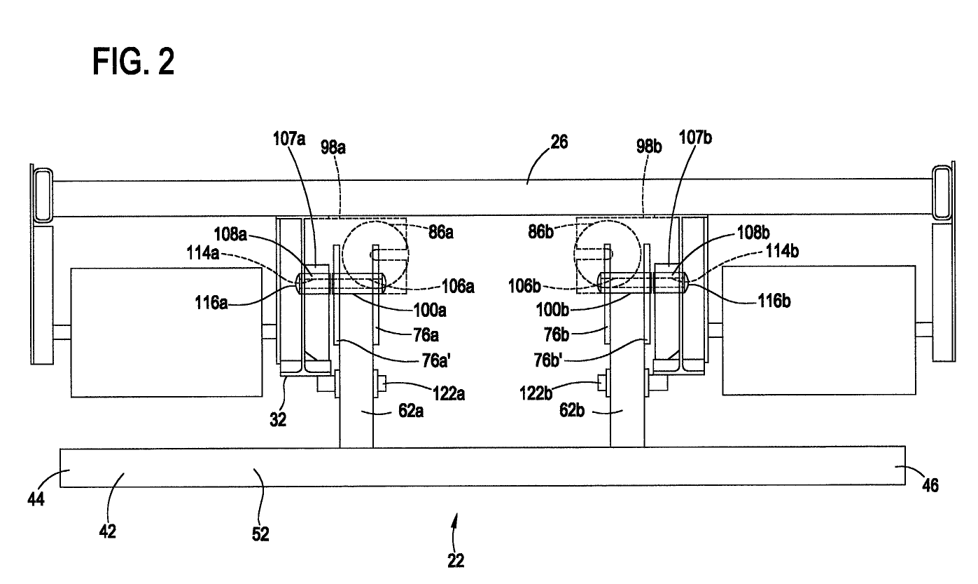

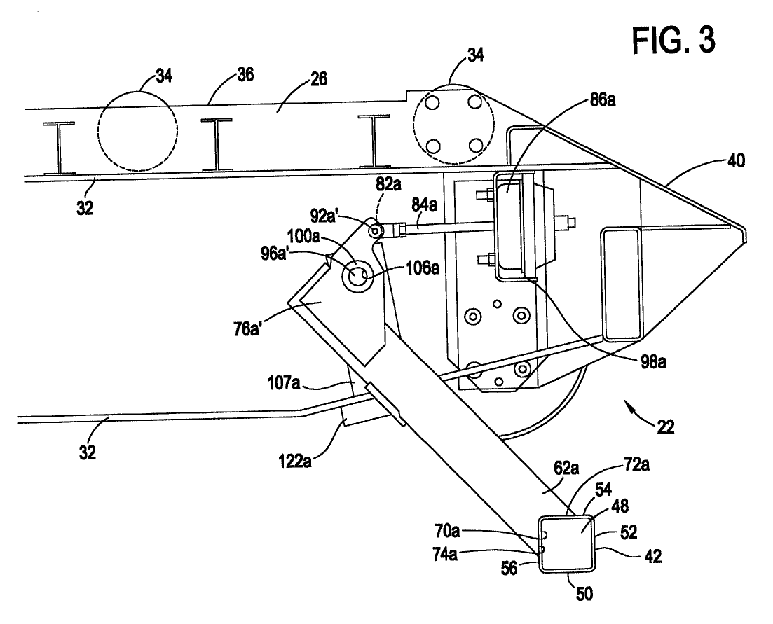

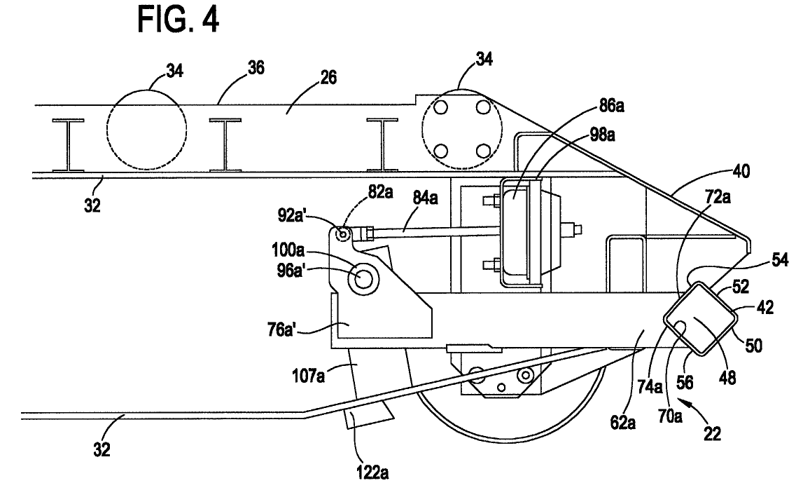

Attention is now directed to FIGS. 2-4. FIGS. 2 and 3 illustrate the rear end 40 of the frame 32 of the trailer 26 showing a bumper 42 of the bumper assembly 22 in a lowered position. When the bumper 42 is in the lowered position, the trailer 26 can be used on roads or highways as the bumper 42 is at a height relative to the road that is commensurate with that required by law for on-the-road driving. FIG. 4 illustrates the rear end 40 of the frame 32 of the trailer 26 showing the bumper 42 of the bumper assembly 22 in a raised position. When the bumper 42 is in the raised position, the bumper 42 is hidden beneath the rear end 40 of the frame 32, thus allowing the rear end 40 of the trailer 26 to be lowered to the ground, as shown in FIG. 1, so that cargo can be removed from the trailer 26. The rollers 34 on the top surface 36 of the trailer 26 can be helpful for rolling cargo off of the trailer 26.

Attention is now directed to FIGS. 3 and 4 which best illustrate the structure of the bumper assembly 22. The bumper 42 is a part of the bumper assembly 22. The bumper 42 has a first end 44, a second end 46, and a bore 48 therethrough that extends from the first end 44 to the second end 46. The bumper 42 is an elongated piece of rigid material and preferably having a square cross-section. Preferably, for the type of trailer 26 shown in FIG. 1, the bumper 42 is 8 feet long, 4 inches wide, and 4 inches thick. The dimensions and shape of the bumper 42 can be altered, though, depending on the type of vehicle the bumper assembly 22 and, thus, the bumper 42 are to be attached to. It should further be noted that the National Highway Traffic Safety Administration of the Department of Transportation has set forth numerous other standards that must also be met so as to reduce the number of deaths and serious injuries that occur when light duty vehicles collide with the rear end of trailers and semitrailers at 37 C.F.R. 571.223. The bumper assembly 22 of the present invention has been tested under these requirements and has been found to exceed these requirements. When the bumper 42 is in its lowered position, a first side 50 of the bumper 42 faces the ground, a second side 52 faces away from the tractor 24, a third side 54 faces the bottom surface 38 of the trailer 26, and a fourth side 56 faces the tractor 24.

At the first end 44 of the bumper 42, a first bumper cap 58 is connected to the bumper 42. The first bumper cap 58 closes off the bore 48 of the bumper 42 at the first end 44 of the bumper 42. Likewise, at the second end 46 of the bumper 42, a second bumper cap 58 is connected to the bumper 42. The second bumper cap 58 closes off the bore 48 of the bumper 42 at the second end 46 of the bumper 42. The bumper caps 58 are best illustrated in FIG. 6.

The bumper assembly 42 further includes a pair of arms 62a, 62b which extend from the bumper 42 toward a front end 64 of the frame 32 of the trailer 26. It should be noted that only one or more than two arms could instead be provided. The distance from the first end 44 of the bumper 42 to the arm 62a is the same as the distance from the second end 46 of the bumper 42 to the arm 62b. The exact distance, though, is defined by the type of vehicle that the bumper assembly 22 is attached to.

The remainder of the bumper assembly will be discussed only with relation to arm 62a and the components of the bumper assembly 22 attached thereto as arm 62b and the components of the bumper assembly 22 attached thereto are the mirror image of that as shown and described in relation to arm 62a.

Arm 62a has a first end attached to the third and fourth sides 54, 56 of the bumper 42 as shown in FIGS. 3 and 4. Because the bumper 42 is square, the first end of the arm 62a has a seat 70a therein that conforms to the third and fourth sides 54, 56 of the bumper 42, thus allowing a first surface 72a of the seat 70a to come into contact with the third side 54 of the bumper 42 while a second surface 74a of the seat 70a comes into contact with the fourth side 56 of the bumper 42.

A pair of bell members 76a, 76a′ are connected to a second end of the arm 62a. Bell member 76a is connected to a first side of the arm 62a and bell member 76a′ is connected to a second, opposite side of the arm 62a. Preferably, the bell members 76a, 76a′ are identical to one another in every respect except that only bell member 76a, and not bell member 76a′, accepts an end 82a of an actuator rod 84a of a brake chamber 86a, as will be described in more detail herein. Therefore, only bell member 76a will be described unless necessary to refer to bell member 76a′.

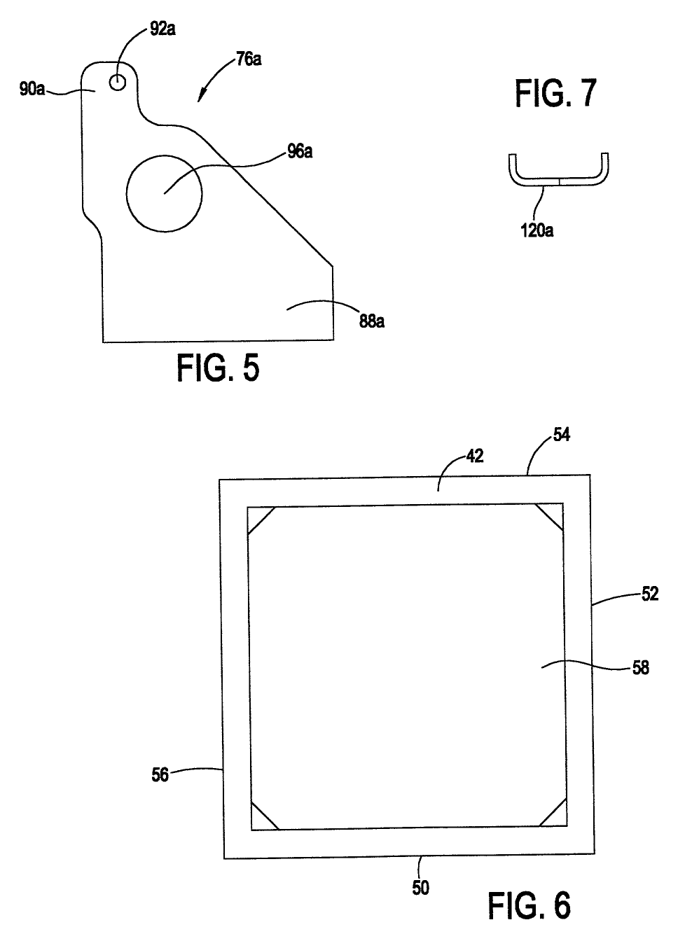

Referring to FIG. 5, bell member 76a includes a large lower portion 88a and a smaller upper portion 90a. As seen best in FIGS. 3 and 4, the large lower portion 88a of the member 76a is connected to the second end of the arm 62a. The upper portion 90a has an aperture 92a proximate to a top of the member 76a. An aperture 96a is provided in the lower portion 88a. The dimensions of the apertures 92a, 96a are defined by the remainder of the structure of the bumper assembly 22, and will become apparent herein. The shape of the bell member 76a in general is defined so that the bell member 76a can accept the full stroke of the actuator rod 84a of the brake chamber 86a and translate the full stroke of the actuator rod 84a into the required movement of the bumper 42 from a lowered position to a raised position and vice versa. The general shape of the bell member 76a as shown in FIG. 5 is the preferred shape of the bell member 76a. The actuator rod 84a of the brake chamber 86a and the brake chamber 86a itself are parts of the bumper assembly 22 and will be discussed further herein.

Aperture 92a of the bell member 76a accepts the end 82a of the actuator rod 84a of the brake chamber 86a such that the end 82a of the actuator rod 84a is connected to the upper portion 90a of the bell member 76a. Aperture 92a′ of the bell member 76a′ does not accept the end 82a of the actuator rod 84a of the brake chamber 86a because the end 82a of the actuator 84a of the brake chamber 86a only needs to attach to one bell member. The actuator rod 84a is capable of moving within a plane due to the activation of the brake chamber 86a and, thus, the actuator rod 84a can move the bell member 76a from a first position, at which the bumper 42 is in its lowered position, to a second position, at which the bumper 42 is in its raised position, defining its stroke length.

The brake chamber 86a is connected to a bracket 98a which is connected to the frame 32 of the trailer 26. The brake chamber 86a can be activated from a remote location on the vehicle 20 by suitable means known in the art.

The bell members 76a, 76a′ are connected to one another by an elongated member 100a which is preferably a tube having a bore 106a therethrough. The first end of member 100a is dimensioned to fit into and through the aperture 96a of bell member 76a and the second end of member 100a is dimensioned to fit into and through the aperture 96a′ of bell member 76a′. The member 100a is connected to the bell members 76a, 76a′ by suitable means, such as welding.

A reinforcement 107a extends upwardly from the frame 32 of the trailer 26. An elongated member 108a, which is preferably a tube having a bore 114a therethrough, is connected to the reinforcement 107a. A first end of the member 108a is proximate to the second end of the member 100a such that the bores 106a, 114a of the members 100a, 108a, respectively, are in axial alignment and communication with one another. The bores 106a, 114a preferably have the same diameter. The second end of the member 108a is fixedly connected to the reinforcement 107a by suitable means, such as welding. The reinforcement 107a provides support for the member 108a.

A connector 116a, preferably a bolt, extends through the bores 106a, 114a to connect the members 100a, 108a. The connector 116a allows member 100a to move relative to member 108a.

The arm 62a has a reinforcement member 120a attached thereto at a position between the first end and the second end of the arm 62a as best shown in FIGS. 3 and 4. More particularly, the reinforcement member 120a attaches to the arm 62a at a position where the arm 62a will abut against a stop 122a attached to the frame 32 of the trailer 26 when the bumper 42 is in its lowered position as shown in FIG. 4. The reinforcement member 120a is generally a U-shaped structure which is dimensioned to fit around, and attach to, the arm 62a. The reinforcement member 120a is shown in FIG. 7.

Preferably, two separate stops 122a, 122b are attached to the frame 32 of the trailer 26, one for arm 62a and one for arm 62b of the bumper assembly 22. However, the stop could also be a single elongated piece that is attached to the frame 32 of the trailer 26 that both arms 62a, 62b of the bumper assembly 22 will abut against.

Operation of the present invention will now be discussed. When the vehicle 20 is driving on the road, the bumper 42 is in its lowered position as shown in FIGS. 2 and 3. When the bumper 42 is in its lowered position, the reinforcement members 120a, 120b that are attached to the arms 62a, 62b, respectively, abut against the stops 122a, 122b which are connected to the frame 32 of the trailer 26. The bumper 42 is held in the lowered position by gravity, i.e., there is no locking mechanism that holds the bumper 42 or the bumper assembly 22 in the lower position. The stops 122a, 122b prohibit any further action being taken on the bumper assembly 22 and the bumper 42 by gravity.

When the bumper 42 is in its lowered position, the bumper is positioned such that the first side 50 of the bumper 42 faces the ground, the second side 52 of the bumper 42 faces away from the tractor 24, the third side 54 of the bumper 42 faces the bottom surface 38 of the trailer 26, and the fourth side 56 of the bumper 42 faces the tractor 24. Further, when the bumper 42 is in its lowered position, the arms 62a, 62b are angled toward the ground relative to the bottom surface 38 of the trailer at approximately a 45 degree angle. Likewise, the arms 62a, 62b are angled from the bumper 42 at a 45 degree angle toward the bottom surface 38 of the trailer 26 as the seats 70a, 70b of the arms 62a, 62b conform to the square cross-section of the bumper 42. Because the arms 62a, 62b of the bumper assembly 22 are angled, the upper portions 90a, 90a′, 90b, 90b′ of the bell members 76a, 76a′, 76b, 76b′ are angled such that the top of the bell members 76a, 76a′, 76b, 76b′ face the bottom surface 38 of the trailer 26 at the rear end 40 of the trailer 26 as shown in FIG. 3. At this position, the actuator rods 84a, 84b of the brake chambers 86a, 86b are not extended and, thus, do not push on the bell members 76a, 76b.

When the vehicle 20 is off the road such that it is time for the cargo situated on the trailer 26 to be removed from the trailer 26, an operator will first remotely activate the brake chambers 86a, 86b, which operate in unison, to raise the bumper 42 to its raised, hidden position beneath the rear end 40 of the trailer 26 as shown in FIGS. 1 and 4. This operation is effected by suitable control circuitry and wiring provided on the trailer 26.

When the brake chambers 86a, 86b are activated, the actuator rods 84a, 84b move within a plane and extend their stroke length from their first position to their second position. When the actuator rods 84a, 84b are moved from their first position to their second position, the actuator rods 84a, 84b also move the bell members 76a, 76b.

Because the bell members 76a, 76b are connected to bell members 76a′, 76b′, respectively, because of the elongated member 100a, 100b, the bell members 76a′, 76b′ will move whenever the bell members 76a, 76b move. Also, because of the connectors 116a, 116b, the bell members 76a, 76a′, 76b, 76b′ and the elongated members 100a, 100b are allowed to move relative to the elongated members 108a, 108b, which are fixed to the frame 32 of the trailer 26.

When the actuator rods 84a, 84b are moved to their second position, the bell members 76a, 76a′, 76b, 76b′ are moved to a position where the tops of the bell members 76a, 76a′, 76b, 76b′ face the bottom surface 38 of the trailer 26 as shown in FIG. 4.

Because the bell members 76a, 76a′, 76b, 76b′ are connected to the arms 62a, 62b, when the bell members 76a, 76a′, 76b, 76b′ are moved, the arms 62a, 62b are also moved. Thus, when the actuator rods 84a, 84b are moved to their second position, the arms 62a, 62b are raised in order to raise the bumper 42 to its raised, hidden position under the rear end 40 of the trailer 26. When the bumper 42 is in its raised, hidden position, the bumper 42 does not extend beyond the rear end 40 of the trailer 26. When the bumper 42 is moved to its raised, hidden position, the arms 62a, 62b of the bumper assembly 22 are generally in a plane that is parallel to a plane of the frame 32 of the trailer 26 as best shown in FIG. 4. Once the bumper 42 has been moved to its raised, hidden position, the brake chambers 86a, 86b continue to hold the bumper 42 in its raised, hidden position.

With the bumper 42 in its raised, hidden position, the operator can then move the frame 32 of the trailer 26 relative to the rear undercarriage assembly 30 by using the slide frame assembly 28. This allows the rear end 40 of the trailer 26 to be placed very close to the ground as shown in FIG. 1. As seen in FIG. 1, the bumper 42 does not touch the ground and does not interfere with the loading or unloading of cargo onto the trailer 26.

Once cargo has either been loaded onto or off of the trailer 26 while it is in its off road position, the rear end 40 of the trailer 26 is raised using the slide frame assembly 28. Once the rear end 40 of the trailer 26 has been raised from the ground, the operator can again remotely operate the brake chambers 86a, 86b, forcing the retraction of the actuator rods 84a, 84b, and thus, the return of the bumper 42 to its lowered position suitable for driving conditions on the road. The bumper 42 will be lowered until the reinforcement members 120a, 120b abut against the stops 122a, 122b attached to the frame 32 of the trailer 26.

With this bumper assembly 22, the operator does not have to be concerned about damaging the bumper assembly 22 if the operator fails to activate the brake chambers 86a, 86b to lower the rear end 40 of the trailer 26 close to the ground. Because the bumper assembly 22 does not have a locking mechanism that locks the bumper 42 in its lowered position, but rather the bumper 42 is only held in its lowered position by the stops 122a, 122b abutting against the reinforcement members 120a, 120b, when the rear end 40 of the trailer 26 is lowered toward the ground, the force of the ground against the bumper 42 will cause the bumper assembly 22 to pivot, thus moving the bumper 42 from its lowered position to its raised position.

It should further be noted that while the use of a brake chamber 86 having an actuator rod 84 thereon is the preferred means of powering the bumper assembly 22 to move the bumper 42 from its lowered position to its raised position and vice versa, other means could also be used to perform this function, such as a hydraulic chamber, an electric actuator, or a winch and reel assembly.

The bumper assembly 22 of the present invention can also be easily removed or retrofitted as well, as the removal of the connectors 116a, 116b will allow for the removal of most of the bumper assembly 22, including the bumper 42, the arms 62a, 62b, the bell members 76a, 76a′, 76b, 76b′, and the elongated members 100a, 100b, thus allowing for a new bumper assembly to be attached.

Also, because much of the bumper assembly 22 of the present invention is not fixedly attached to the frame 32 of the trailer 32 the bumper assembly 22 should deform or fail in a manner that does not harm the trailer 26 in a manner that other standard frame mounted rear underride bumpers would as the stress will not be transferred as easily from the bumper assembly 22 to the trailer 26.

It should further be noted that with some minor rearrangements of the bumper assembly in relation to the frame of the vehicle, i.e., moving the brake chambers forward from the rear end of the vehicle toward the front end of the vehicle, making minor changes to the shape of the bell members, etc., the movement of the bumper from its lowered position to its raised position could be reversed, such that the bumper, in moving from its lowered position to its raised position, would move toward the front end of the vehicle rather than toward the rear end of the vehicle.

While embodiments of the present invention are shown and described, it is envisioned that those skilled in the art may devise various modifications without departing from the spirit and scope of the foregoing description.

The invention is claimed as follows:

1. A bumper assembly for attachment to a vehicle comprising:
a bumper;
at least one arm having first and second ends, said first end of said at least one arm being attached to said bumper;
a connection assembly attached to said second end of said at least one arm and to a frame of the vehicle; and
means for moving said connection assembly such that said bumper can be moved between a lowered position and a raised position.

2. A bumper assembly as defined in claim 1, wherein said bumper has a bore therethrough that extends from a first end of said bumper to a second end of said bumper, said bore being enclosed by a first cap member and a second cap member, said first and second cap members are connected to said first end and said second end, respectively, of said bumper.

3. A bumper assembly as defined in claim 1, wherein said first end of said at least one arm defines a seat therein that conforms to an outside surface of said bumper.

4. A bumper assembly as defined in claim 1, further comprising means for prohibiting movement of said at least one arm such that said bumper cannot move beyond said lowered position.

5. A bumper assembly as defined in claim 4, further comprising at least one reinforcement member attached to said at least one arm, said at least one reinforcement member abutting against said prohibiting means when said bumper is in said lowered position.

6. A bumper assembly as defined in claim 1, wherein said connection assembly comprises:
a first member attached to said second end of said at least one arm at a first side thereof;
a second member attached to said second end of said at least one arm at an opposite, second side thereof; and
a connection means extending between said first and second members and connected to the frame of the vehicle, said connection means allowing for the movement of said first and second members relative to the frame of the vehicle.

7. A bumper assembly as defined in claim 6, wherein said connection means includes a first tube extending through said first member and said second member, a second tube connected to the frame, and a fastener extending through said first and second tubes.

8. A bumper assembly as defined in claim 1, wherein said moving means comprises an air brake chamber having a rod extending therefrom.

9. A bumper assembly as defined in claim 8, wherein said air brake chamber is connected to the frame of the vehicle, said rod being connected to said connection assembly, said rod capable of moving within a plane when said air brake chamber is activated such that said rod can move said connection assembly, allowing said bumper to move between said lowered position and said raised position.

10. A vehicle comprising:
a frame; and
a bumper assembly at a rear end of said frame, said bumper assembly comprising:
a bumper,
at least one arm having first and second ends, said first end of said at least one arm being attached to said bumper,
a connection assembly attached to said second end of said at least one arm and to said frame of said vehicle, and
means for moving said connection assembly such that said bumper can be moved between a lowered position and a raised position.

11. A vehicle as defined in claim 10, wherein said bumper has a bore therethrough that extends from a first end of said bumper to a second end of said bumper, said bore being enclosed by a first cap member and a second cap member, said first and second cap members are connected to said first end and said second end, respectively, of said bumper.

12. A vehicle as defined in claim 10, wherein said first end of said at least one arm defines a seat therein that conforms to an outside surface of said bumper.

13. A vehicle as defined in claim 10, wherein said at least one arm extends at approximately a 45 degree angle relative to said frame when said bumper is in said lowered position.

14. A vehicle as defined in claim 10, wherein said bumper assembly further comprises means for prohibiting movement of said at least one arm such that said bumper cannot move beyond said lowered position.

15. A vehicle as defined in claim 14, wherein said bumper assembly further comprises at least one reinforcement member attached to said at least one arm, said at least one reinforcement member abutting against said prohibiting means when said bumper is in said lowered position.

16. A vehicle as defined in claim 10, wherein said connection assembly comprises:
a first member attached to said second end of said at least one arm at a first side thereof;
a second member attached to said second end of said at least one arm at an opposite, second side thereof; and
connection means extending between said first and second members and connected to the frame of the vehicle, said connection means allowing for the movement of said first and second members relative to the frame of the vehicle.

17. A vehicle as defined in claim 16, wherein said connection means includes a first tube extending through said first member and said second member, a second tube connected to the frame, and a fastener extending through said first and second tubes.

18. A vehicle as defined in claim 17, wherein said connection assembly further comprises a reinforcement member attached to said frame, said reinforcement member supporting said second tube.

19. A vehicle as defined in claim 10, wherein said moving means comprises an air brake chamber having a rod extending therefrom.

20. A vehicle as defined in claim 19, wherein said air brake chamber is connected to said frame, said rod being connected to said connection assembly, said rod capable of moving within a plane when said air brake chamber is activated such that said rod can move said connection assembly, allowing said bumper to move between said lowered position and said raised position.

21. A vehicle as defined in claim 10, wherein said bumper is generally within a plane of a rear end of said frame when said bumper is in said raised position.

22. A method of lowering a rear end of a vehicle comprising the steps of:
a) providing a frame, a rear undercarriage assembly and a bumper;
b) moving said bumper from a lowered position suitable for on the road activity to a raised position suitable for off the road activity, said bumper being generally within a plane of said rear end of said frame when said bumper is in said raised position;
c) moving said rear undercarriage assembly toward a front end of said frame; and
d) lowering said rear end of said frame about said rear undercarriage assembly.
